(19) United States
(12) Patent Application Publication
(10) Pub. No.: US 2021/0323231 A1
(43) Pub. Date: Oct. 21, 2021

(54) LIQUIFIER ASSEMBLY

(71) Applicant: Fusion3 Design LLC, Greensboro, NC (US)

(72) Inventors: Katelyn Padgett, Whitsett, NC (US); Nate Cross, Greensboro, NC (US)

(21) Appl. No.: 17/216,073

(22) Filed: Mar. 29, 2021

Related U.S. Application Data
(60) Provisional application No. 63/000,629, filed on Mar. 27, 2020.

(51) Int. Cl. B29C 64/314; B29C 64/209; B29C 64/295; B29C 64/118; B29C 64/321; B29C 64/393; B33Y 30/00; B33Y 40/10; B33Y 50/02

(52) U.S. Cl. CPC B29C 64/314; B29C 64/209; B29C 64/295; B29C 64/118; B33Y 50/02; B29C 64/393; B33Y 30/00; B33Y 40/10; B29C 64/321

(57) ABSTRACT

An apparatus is provided for liquefying a filament of a solid state material. The liquefying apparatus comprises a hollow tube having a longitudinal length extending between a proximal inlet end and an outlet nozzle at a distal end. The tube defines a passage for passing the material in solid and molten states. A cold block unit is mechanically attached to the tube. A heating block unit is mechanically attached to the tube and positioned along the longitudinal axis of the tube between the cold block and the distal end of the tube for heating the tube to convert the material received at the proximal inlet end of the tube to a molten form. The material advances through the passage from the inlet end to the distal outlet end such that the molten material is extruded from the nozzle for printing each layer of the three-dimensional object.

### BACKGROUND

A liquifier assembly is described for use in a print head of an additive manufacturing system for building three-dimensional (3D) models and, more particularly, a liquifier assembly for extruding thermoplastic-based materials for use in extrusion-based additive manufacturing systems.

An extrusion-based additive manufacturing system is used to build a 3D model from a digital representation of the 3D model in a layer-by-layer manner by extruding a flowable modeling material through a liquifier assembly carried by a print head. The material is deposited as a sequence of layers on a substrate in an x-y plane. The additive manufacturing system can include a build chamber, a platen serving as the substrate, a movable gantry supporting the print head for building the 3D model, a corresponding support structure, and a supply source of modeling material. The modeling material is supplied to the print head from the supply source in the form of a continuous filament for allowing the print head to deposit the modeling material on the platen to build the 3D model. Examples of suitable systems include an extrusion-based additive manufacturing system available from Fusion3 of Greensboro, N.C.

In operation, a mechanical feeding mechanism pulls the filament from a supply spool and pushes the filament into the print head. The liquifier assembly, including a distal extrusion nozzle, heats the filament for melting the material and letting it flow through the nozzle. 3D model is produced by extruding thermoplastic material to form layers as the material hardens immediately after extrusion from the nozzle.

One of the most common problems with the print head is material becoming stuck inside the nozzle. When maintenance is required, conventional print heads must be completely disassembled and cleaned out, or replaced.

For the foregoing reasons, there is a need for a liquifier assembly that minimizes occurrences of blockage. Ideally, the improved liquifier assembly should easy to repair or replace when necessary, and should be low cost to manufacture.

### SUMMARY

An apparatus is provided for liquefying a filament of a solid state material for use in an additive manufacturing system, including a drive mechanism for feeding the material for printing a three dimensional object. The liquefying apparatus comprises a hollow tube having a longitudinal length extending between a proximal inlet end for receiving the thermoplastic material and an outlet nozzle at a distal end. The tube defines a passage for passing the material in solid and molten states. A cold block unit and a heating block unit are mechanically attached to the tube. The heating block is positioned along the longitudinal axis of the tube between the cold block and the distal end of the tube for heating the tube to convert the material received at the proximal inlet end of the tube to a molten form. The material advances through the passage from the inlet end to the distal outlet end of the tube such that the molten material is extruded from the nozzle for printing each layer of the three-dimensional object.

In one aspect, the liquefying apparatus further comprises a fan for forced air cooling of the cold block. The cold block and the heating block are spaced along the length of the tube for a distance thereby forming a heat break.

In another aspect, the tube has a wall thickness of about 0.5 mm.

The liquefying apparatus may further comprise a controller configured to operate the heating block to provide a heatable zone along the longitudinal length of the tube for melting the material. In one aspect, a temperature sensor is configured to detect a temperature of the heating block and to relay the detected temperature to the controller.

The liquefying apparatus may still further comprise an electrically conductive component configured to heat the heating block. The electrically conductive component comprises an electrical wire.

In yet another aspect, the liquefying apparatus may further comprising a heat shield positioned along the longitudinal length of the tube between the heating block and the distal end of the tube.

In one embodiment, the heating block includes a first plate having a first surface that defines a first groove, and a second plate that includes a second surface that defines a second groove, wherein the first and second surfaces of the first and second plates are in abutting contact with the first and second grooves aligned to define a passage for receiving the tube.

An additive manufacturing system for printing a three dimensional object comprises a drive mechanism for feeding a filament of a solid state material and a liquefying apparatus for receiving the material. The liquefying apparatus comprises a hollow tube having a longitudinal length extending between a proximal inlet end for receiving the thermoplastic material and an outlet nozzle at a distal end. The tube defines a passage for passing the material in solid and molten states. A cold block unit and a heating block unit are mechanically attached to the tube. The heating block is positioned along the longitudinal axis of the tube between the cold block and the distal end of the tube for heating the tube to convert the material received at the proximal inlet end of the tube to a molten form. The material advances through the passage from the inlet end to the distal outlet end such that the molten material is extruded from the nozzle for printing each layer of the three-dimensional object.

In one aspect, the additive manufacturing system may further comprise a fan for forced air cooling of the cold block. The cold block and the heating block may be spaced along the length of the tube for a distance thereby forming a heat break.

In another aspect, the tube has a wall thickness of about 0.5 mm.

The additive manufacturing system may further comprise a controller configured to operate the heating block to provide a heatable zone along the longitudinal length of the tube for melting the material. A temperature sensor configured to detect a temperature of the heating block may relay the detected temperature to the controller.

The additive manufacturing system may further comprise an electrically conductive component configured to heat the heating block. The electrically conductive component may comprise an electrical wire.

In yet another aspect, the additive manufacturing system may further comprise a heat shield positioned along the longitudinal length of the tube between the heating block and the distal end of the tube.

In one embodiment of the additive manufacturing system, the heating block includes a first plate having a first surface that defines a first groove, and a second plate that includes a second surface that defines a second groove, wherein the first and second surfaces of the first and second plates are in abutting contact with the first and second grooves aligned to define a passage for receiving the tube.

### BRIEF DESCRIPTION OF THE DRAWINGS

For a more complete understanding of the apparatus, reference should now be had to the embodiments shown in the accompanying drawings and described below. In the drawings:

FIG. 1 is a front elevation view of an embodiment of a liquifier assembly for use in an additive manufacturing system.

FIG. 2 is a rear elevation view of the liquifier assembly as shown in FIG. 1.

FIG. 3 is a top plan view of the liquifier assembly as shown in FIG. 1.

FIG. 4 is a bottom plan view of the liquifier assembly as shown in FIG. 1.

FIG. 5 is a right side elevation view of the liquifier assembly as shown in FIG. 1.

FIG. 6 is a top exploded perspective view of the liquifier assembly as shown in FIG. 1.

FIG. 7 is a bottom exploded perspective view of the liquifier assembly as shown in FIG.

FIG. 8 is a front right perspective view of a longitudinal cross-section of the liquifier assembly as shown in FIG. 1.

FIG. 9 is a rear left perspective view of a longitudinal cross-section of the liquifier assembly as shown in FIG. 1.

FIGS. 10A and 10B are a front elevation and longitudinal cross-section views, respectively, of an embodiment of a tube for use in the liquifier assembly as shown in FIG. 1.

FIGS. 11A-11F are top plan, front elevation, bottom plan, front perspective, rear elevation and right side elevation views, respectively, of an embodiment of a hot block for use in the liquifier assembly as shown in FIG. 1.

FIGS. 12A-12F are top plan, rear elevation, bottom plan, front perspective, front elevation and right side elevation views, respectively, of an embodiment of a cold block body for use in the liquifier assembly as shown in FIG. 1.

FIGS. 13A-13E are rear elevation, top plan, right side elevation, front elevation and rear perspective views, respectively, of an embodiment of a cold block clamp for use in the liquifier assembly as shown in FIG. 1.

FIG. 14 is a front perspective view of another embodiment of a liquefier assembly for use in an additive manufacturing system.

FIG. 15 is a right side elevation view of the liquifier assembly as shown in FIG. 14.

FIG. 16 is front top right perspective view of a cold block and hot block assembly for use with the liquifier assembly as shown in FIG. 14.

FIG. 17 is front bottom right perspective view of another embodiment of a cold block and hot block assembly for use with the liquifier assembly as shown in FIG. 14.

FIG. 18 is a front elevation view of the assembly shown in FIG. 17.

FIG. 19 is a top plan view of the assembly as shown in FIG. 17.

FIG. 20 is a bottom plan view of the assembly as shown in FIG. 17.

FIG. 21 is a left side elevation view of the assembly as shown in FIG. 17.

FIG. 22 is front top right partially exploded perspective view of the assembly as shown in FIG. 17.

FIG. 23 is a front bottom right partially perspective view of the assembly as shown in FIG. 17.

FIG. 24 is a front top right exploded perspective view of the assembly as shown in FIG. 17.

FIG. 25 is a front right perspective view of a longitudinal cross-section of the liquefier assembly as shown in FIG. 14.

FIG. 26 is a right side elevation view of a longitudinal cross-section of the liquifier assembly as shown in FIG. 14.

FIG. 27 is a front elevation view of a longitudinal cross-section of the liquifier assembly as shown in FIG. 14.

FIG. 28 is a front perspective view of a third embodiment of a liquefier assembly for use in an additive manufacturing system.

FIG. 29 is a front right perspective view of a longitudinal cross-section of the liquefier assembly as shown in FIG. 28.

FIGS. 30A-30E are right side elevation, front elevation, top plan, front perspective and left side elevation views, respectively, of a center portion of an embodiment of a hot block assembly for use in the assembly shown in FIG. 17.

FIGS. 31A-31E are right side elevation, top plan, front elevation, front perspective and left side elevation views, respectively, of a rear portion of for use with the hot block assembly shown in FIG. 17.

FIGS. 32A-32E are left side elevation, rear elevation, top plan, front perspective and right side elevation views, respectively, of a front portion for use with the hot block assembly shown in FIG. 17.

### DESCRIPTION

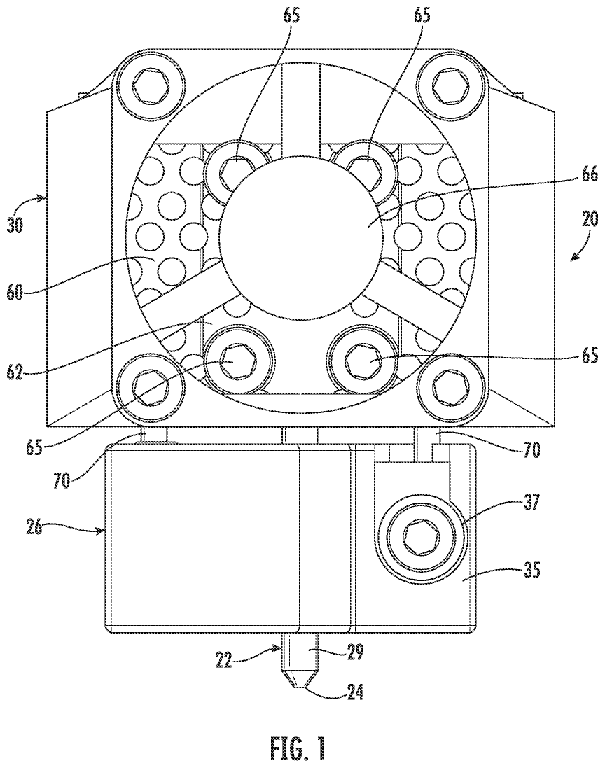

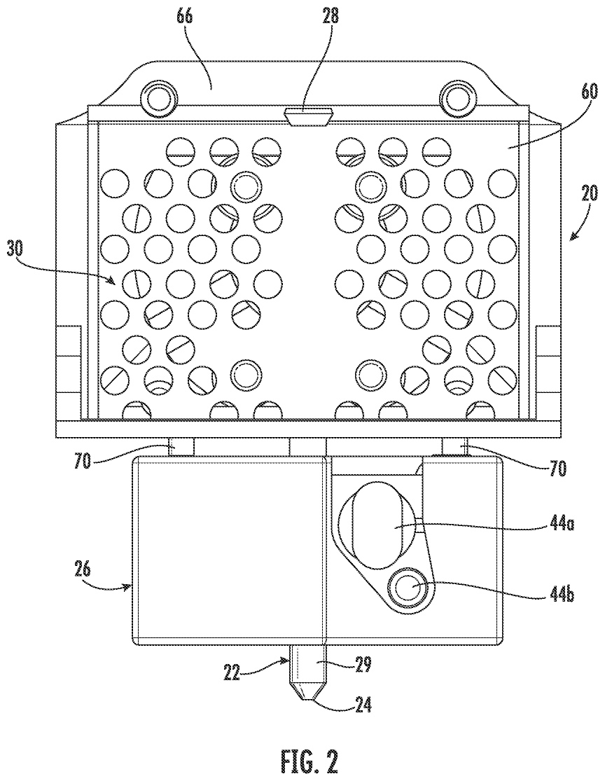

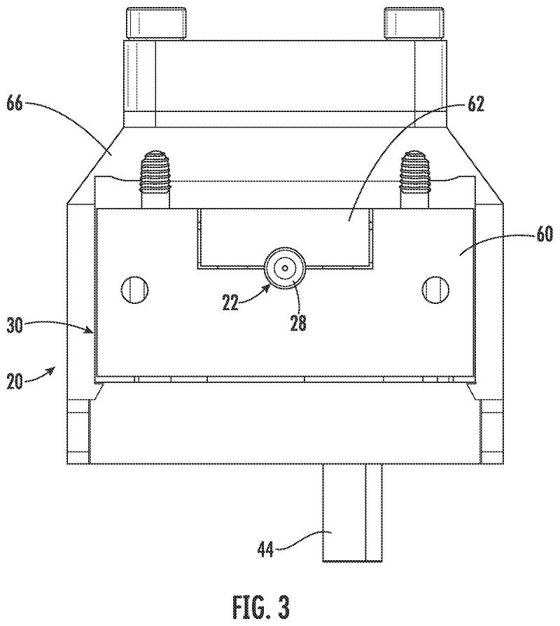

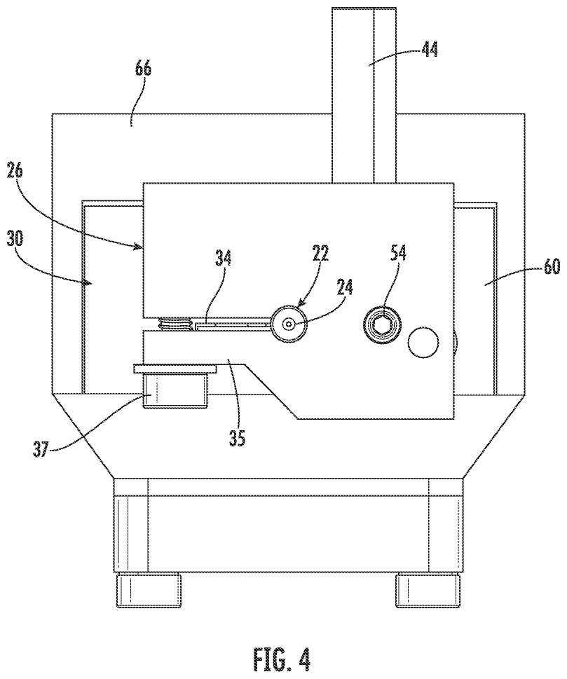

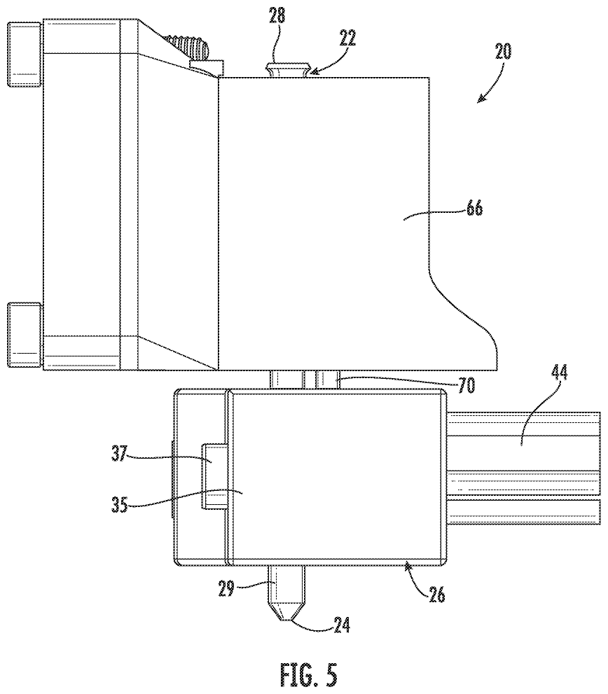

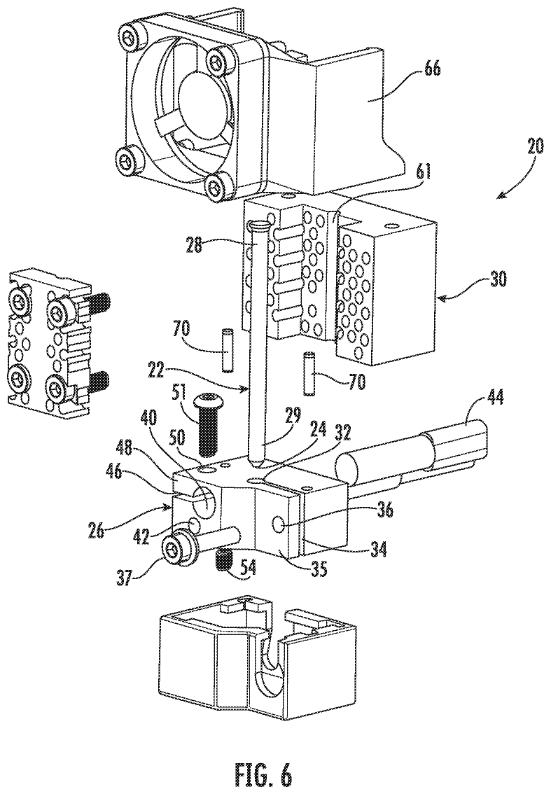

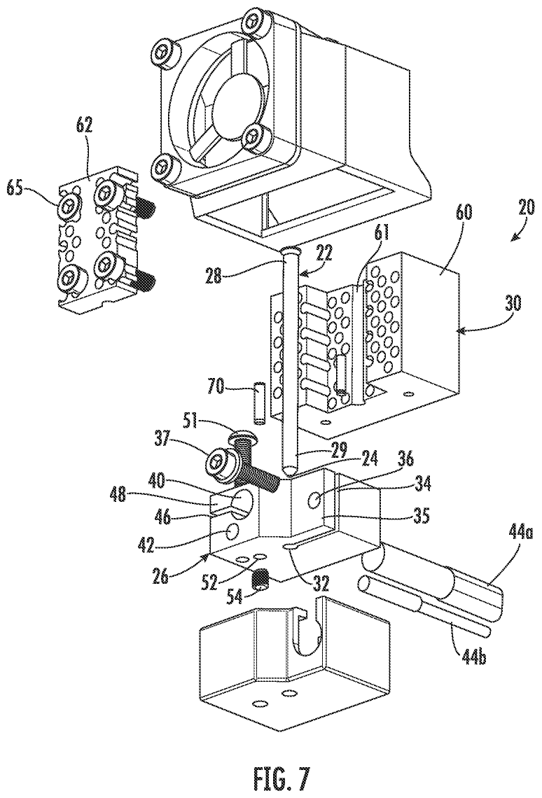

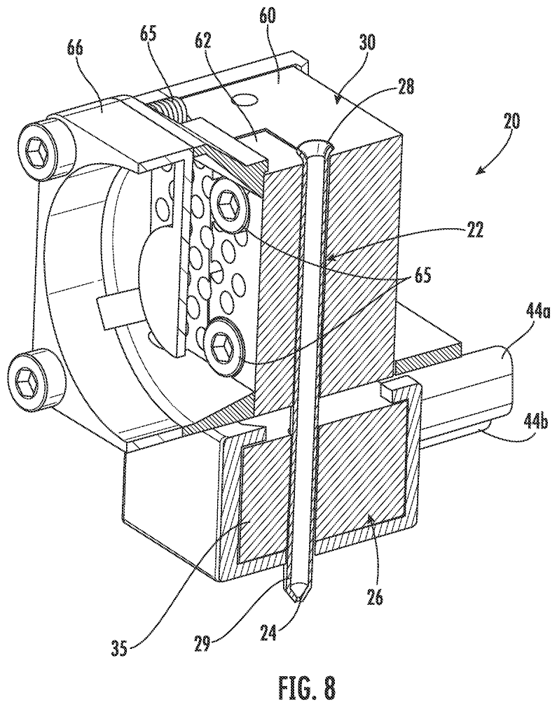

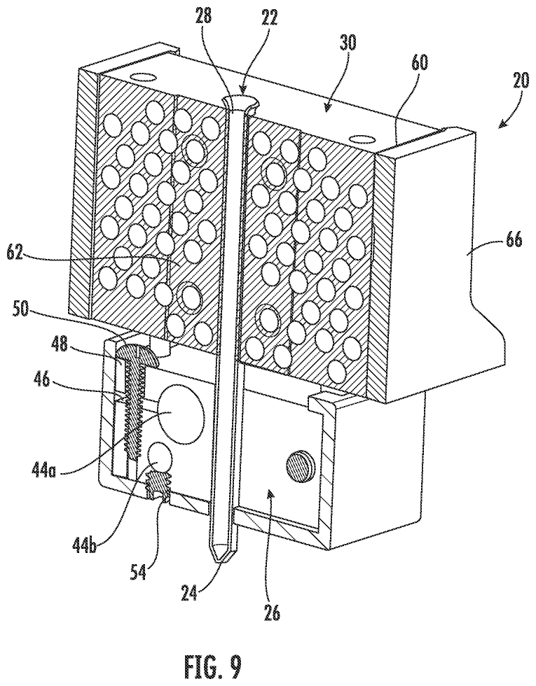

Referring now to the drawings, an embodiment of a liquifier assembly for use in a print head of an extrusion-based additive manufacturing system is shown in FIGS. 1-7 and generally designated at 20. An example of an additive manufacturing system for use with the liquefier is described in U.S. Pat. No. 10,780,628, the contents of which are incorporated herein by reference in their entirety. The liquifier assembly 20 is configured for extruding a modeling material from a filament fed by a drive mechanism from a supply source. The liquifier assembly 20 generally comprises a thin walled tube 22 having an extrusion nozzle 24 tip at a distal end, a heating block 26 secured to the tube 22 adjacent to the nozzle 24, and a cold block 30 also secured along the length of the tube 22 spaced from the heating block 26 between the heating block 26 and a proximal end 28 of the tube 22. The liquifier assembly 20 is used in a method for building a three-dimensional (3D) model in an extrusion-based additive manufacturing system having a print head. The method includes providing the tube 22 in the print head, the tube including the heating block 26 and the cooling block 30 spaced along a longitudinal length of the tube, feeding a filament of thermoplastic modeling material into the tube 22, cooling a first portion of the tube 22 at the cooling block 30, and heating a second portion of the tube at the heating block 26 sufficiently for at least partially melting a portion of the filament within the tube 22, and extruding the molten thermoplastic material from the nozzle tip 24 to deposit the modeling material.

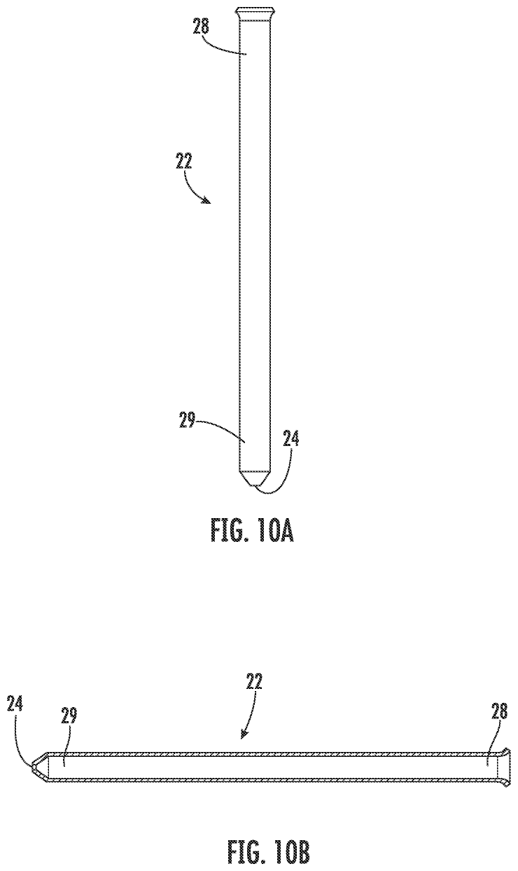

Referring to FIG. 10, the thin walled tube 22 is a linear elongated piece having a longitudinal axis extending from the proximal inlet end 28 to the distal end 29 and nozzle tip 24. The tube 22 is hollow and adapted for passing modeling material as the material is conveyed from the inlet end 28 to the outlet end 29. The inlet end 28 of the tube 22 is swaged open slightly to aid in positioning the tube in the liquifier assembly 20. The nozzle 24 of the tube 22 is formed into the distal outlet end 29 such that the tube 22 and nozzle 24 are a unitary, monolithic piece. The section of the tube 22 forming the nozzle 24 may have a cone-shaped profile as shown. The embodiment of the tube 22 as shown has a cylindrical geometry extending along the longitudinal axis. However, it is understood that the tube 22 may have a non-cylindrical geometry, such as elliptical, polygonal (e.g., rectangular and square geometries), axially-tapered geometries, and the like.

The tube 22 is formed from metal tubing, such as stainless steel tubing, to have thin walls. This manufacturing method reduces the cost of the tube 22 while providing a smooth interior surface finish for the tube. If the tube were machined or deep-drawn from a plate or drilled out, polishing of the inner surface would be required. In one embodiment, the tube 22 is about 40 mm to about 45 mm in length. The wall of the tube 22 has a thickness of about 0.5 mm. The inside diameter of the tube is about 1.9 mm, which is approximately 10% greater than the diameter of the thermoplastic filament modeling material that is fed through the tube 22. The nozzle 24 has a specific orifice diameter of about 0.4 mm, which is configured to extrude material at a predetermined width. Other orifice diameters in the range of 0.2 mm to 1.0 mm are possible as it is understood that the length and diameter of the tube are potentially limitless depending on their use and application.

One embodiment of the heating block 26, as shown in FIG. 11, is a generally rectangular member made from a thermally conductive material, such as aluminum or copper, or other metal with high thermal conductivity, and a melting point sufficiently above the print head's maximum design operating temperature. The heating block 26 has a thickness of about one half inch along a longitudinal axis. The heating bock 26 has a longitudinal passage 32 for receiving the tube 22. When in place, about 1 mm to about 4 mm of the distal end 29 of the tube 22 and nozzle 24 extends from the bottom of the heating block 26. A longitudinal slot 34 extends from the outer surface at one end of the heating block 26 and opens into the passage 32 forming a free arm 35. The free arm 35 defines a threaded opening 36 extending into the heating block 26 for receiving a bolt 37 for clamping the tube 22 in the heating block 26.

The other end of the heating bock 26 has two transverse passages 40, 42 for receiving electrical wire 44. A transverse slot 46 extends from the outer surface at the end of the heating block 26 and opens into the larger wire passage 40 forming a free arm 48. The free arm 48 defines a threaded opening 50 extending into the heating block 26 for receiving a bolt 51 for clamping the larger wire 44a in the heating block 26. A threaded opening 52 in the bottom surface of the heating block 26 opens into the smaller passage 42 receiving the smaller wire 44b. A set screw 54 in the threaded opening 52 secures the smaller wire 44b. The larger wire 44a delivers power to an electrical heating element for raising the temperature of the heating block 26. The smaller wire 44b delivers power to a temperature sensor (not shown) for closed-loop temperature control of the heating block 26.

The heating block 26 is configured to transfer thermal energy to the tube 22 via conduction in order to heat the modeling material passing through the tube 22 to above the melting point. During operation, electrical current is supplied via the wire 44 to the heating block 26. The heat from the heating block 26 is then transferred to the tube 22. While the liquifier assembly 20 is shown having one heating block 22, the liquifier assembly 20 may alternatively include additional heating blocks. In general, the heating block is kept as small as possible to reduce “thermal inertia” to enable more rapid and precise control of the temperature of the block.

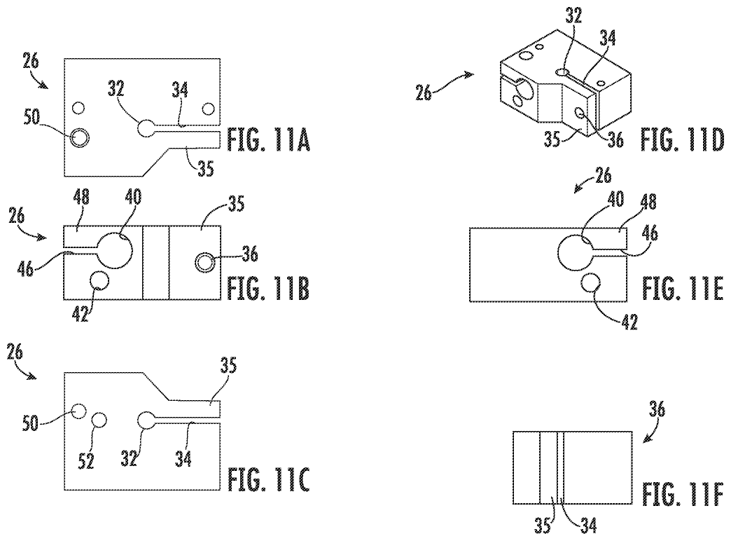

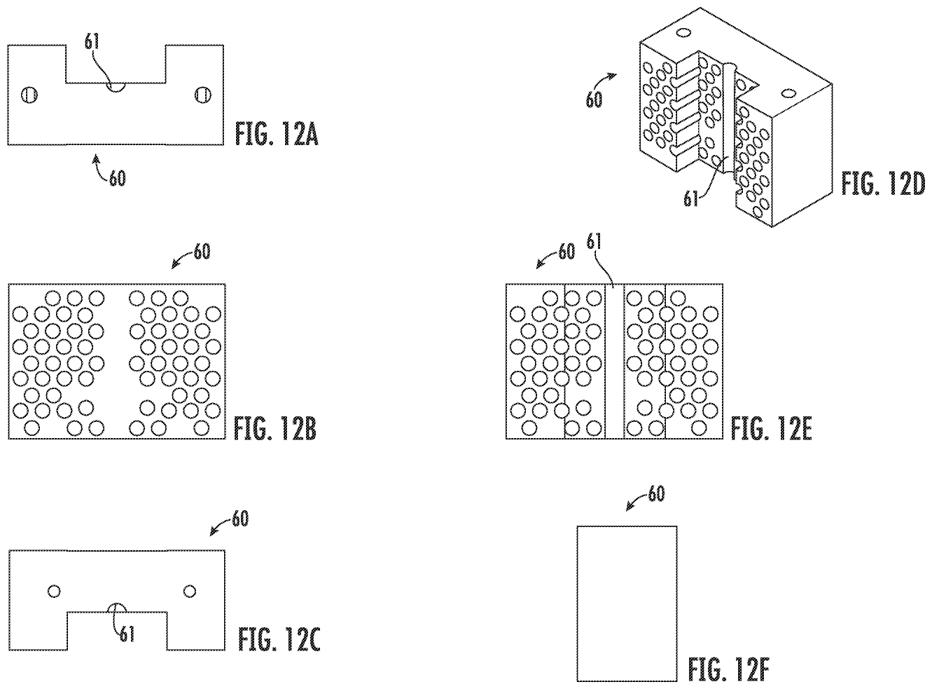

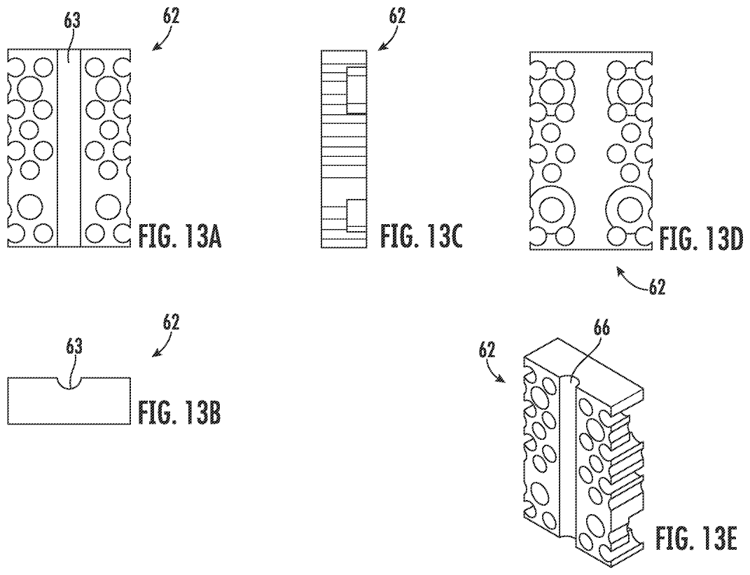

An embodiment of the cold block 30 is shown in FIGS. 12 and 13. The cold block 30 comprises a C-shaped body portion 60 and a clamp portion 62 and is about one inch thick. Each of the body 60 and the clamp 62 defines a semi-circular longitudinal groove 61, 63 for receiving the tube 22. Four threaded openings 64 in the body 60 and the clamp 62 receive bolts 65 for securing a length of the tube in the cold block 30 proximal of the heating block 26.

The cold block 30 is actively cooled with cooling air supplied by a fan 66 as shown. The temperature of the tube 22 in the cold block 30 is maintained below the glass transition temperature of the modeling material. Although a fan 66 is shown, alternative means may be used for cooling the tube 22, such as a water jacket, a piezoelectric cooler, peltier or other cooling means. The temperature at the proximal end 28 of the tube 22 is thus below the softening point of the modeling material being fed to the liquifier assembly 20 to prevent the material from prematurely softening.

The heating block 26 and the cold block 30 are held in alignment using two or more dowel pins 70 that are press fit into each of the heating bock 26 and the cooling block 30. The dowel pins 70 maintain the spacing and relative orientation of the heating block 26 and the cold block 30. The dowel pins 70 are made of stainless steel or other material with high thermal resistance to reduce heat transfer.

When the liquifier assembly 20 is assembled, there is about a 2 to about a 3 mm heat break portion of tube 22 between the heating block 26 and the cold block 30 where the tube 22 is exposed to ambient air. The heat break isolates the heating block 26 and the cold block 30 for selective, localized heating and cooling of the tube 22. The result is a sharp thermal gradient or profile along the longitudinal length of the tube 22. The purpose of this thermal gradient is to maintain precise control over the flow of molten material from the tip of the nozzle. By keeping the volume of material that is in a semi-molten state to a minimum, more precise control over the extrusion is achieved.

The liquifier assembly 20 may include a controller. The controller may comprise one or more processor-based controllers that communicate over signal lines, including one or more electrical, optical, or wireless signal lines, allowing the controller to communicate with various components of liquifier assembly 20. Sensors, such as thermocouples, may monitor the temperature of the components. The output from the thermocouples are used by the controller to control the current or air flow based on target temperatures.

In use, the liquifier assembly 20 is installed on the print head of an additive manufacturing system. A filament of modeling material is pushed by a drive mechanism into the inlet at the proximal end 28 of the tube 22 adjacent the cold block 30. Cooling air is blown by the fan 66 toward the proximal end 28 of the tube 22. The cooling air reduces the temperature of the tube 22 at the inlet proximal end 28 such that the cold block 30 maintains the material in a solid state below the glass transition temperature of the material. The material is advanced along the tube 22 to the heating block 26 where the material is melted by heat generated by the heating block 26 and transferred to the tube 22. The material is extruded in liquid form through the nozzle 24 at a temperature well above its melt temperature, and deposited onto, for example, a platen for building a 3D object in a layer-by-layer manner. The heat break between the cold block 30 and the heating block 26 isolates the cold end of the tube 22 from the higher temperatures in the hot end of the tube.

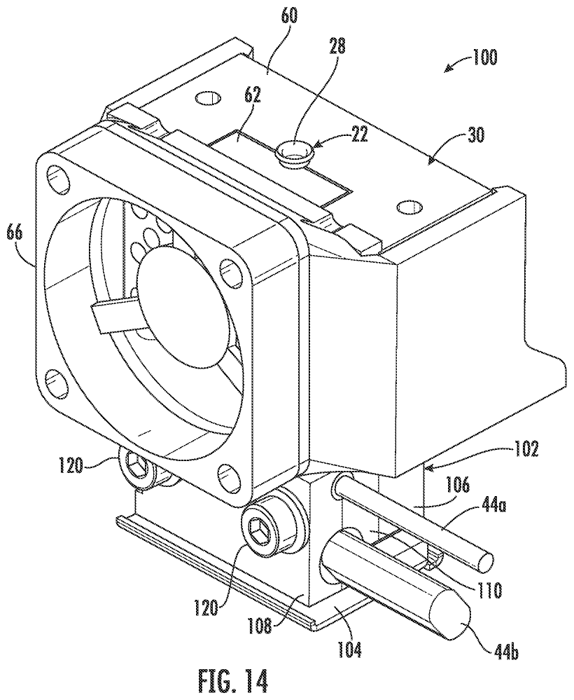

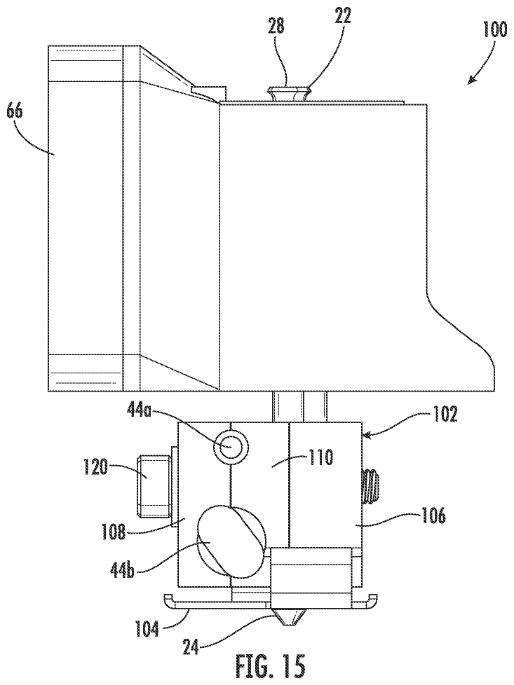

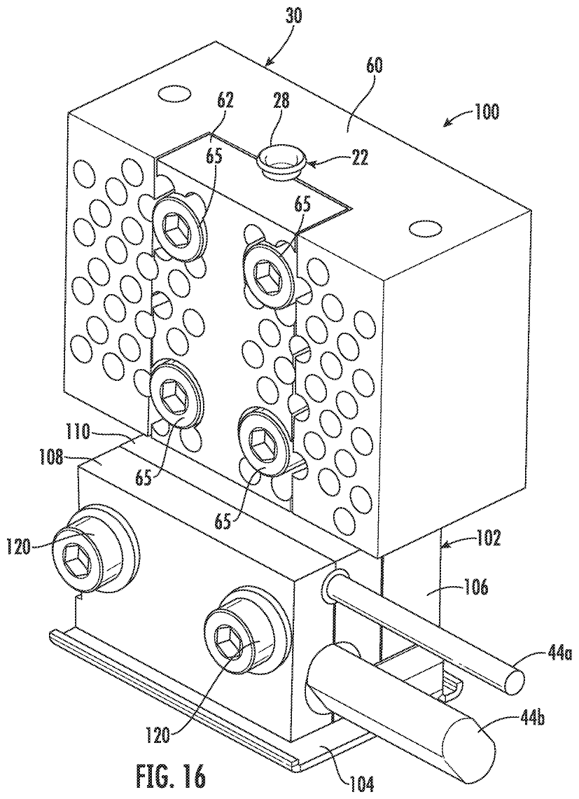

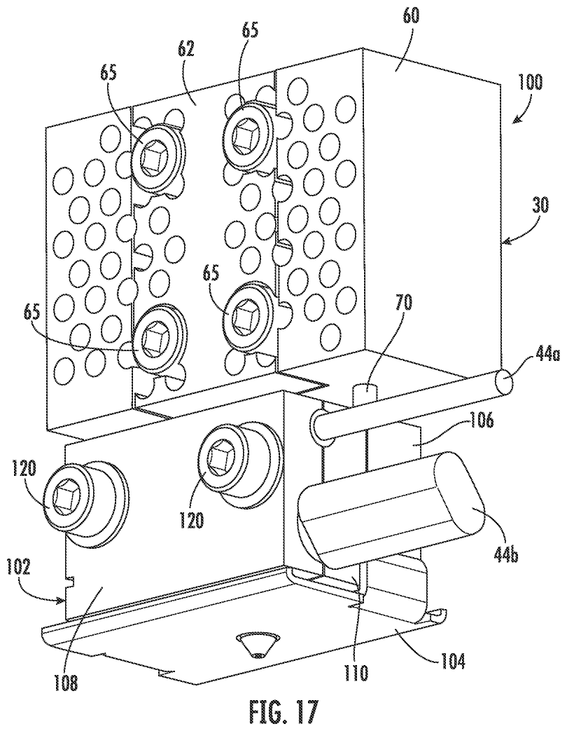

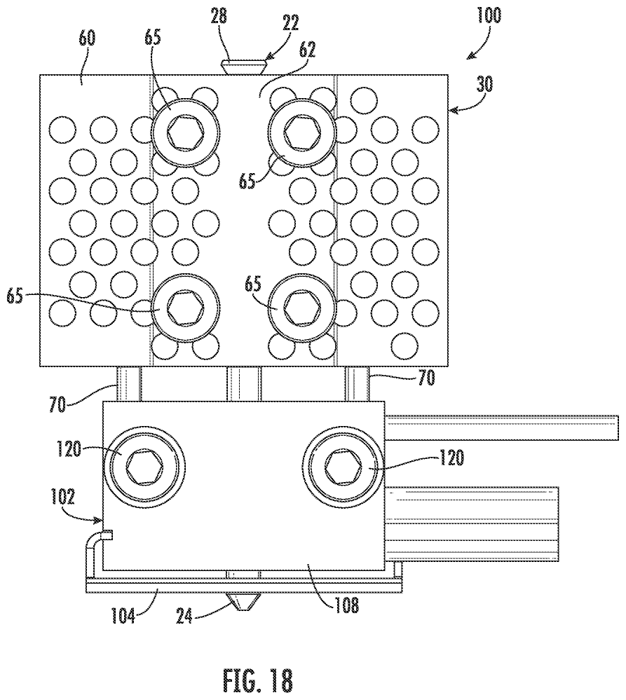

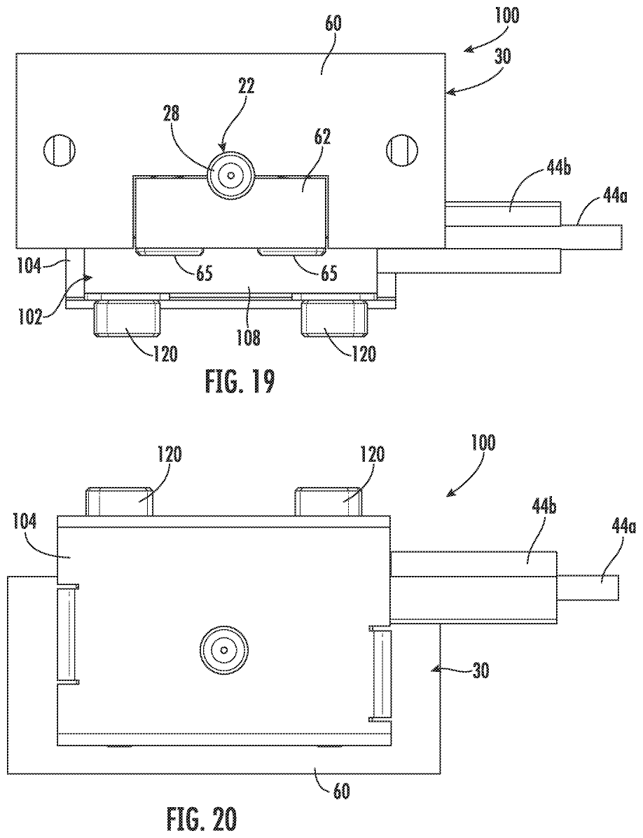

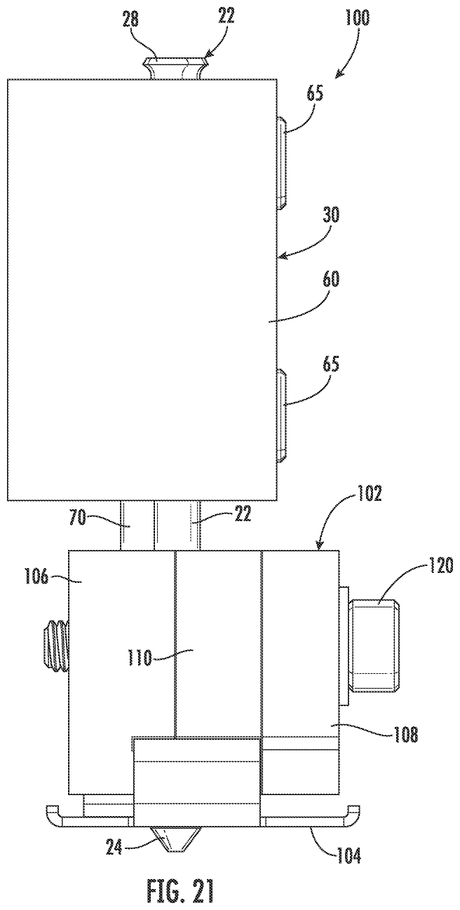

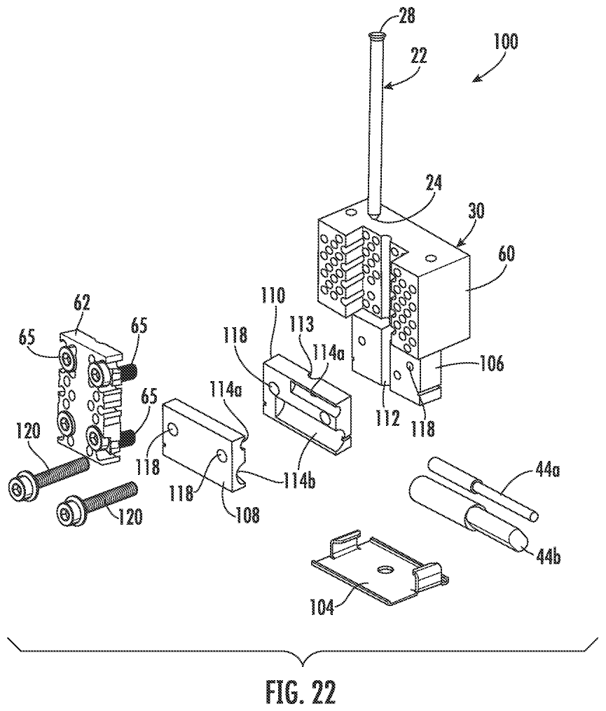

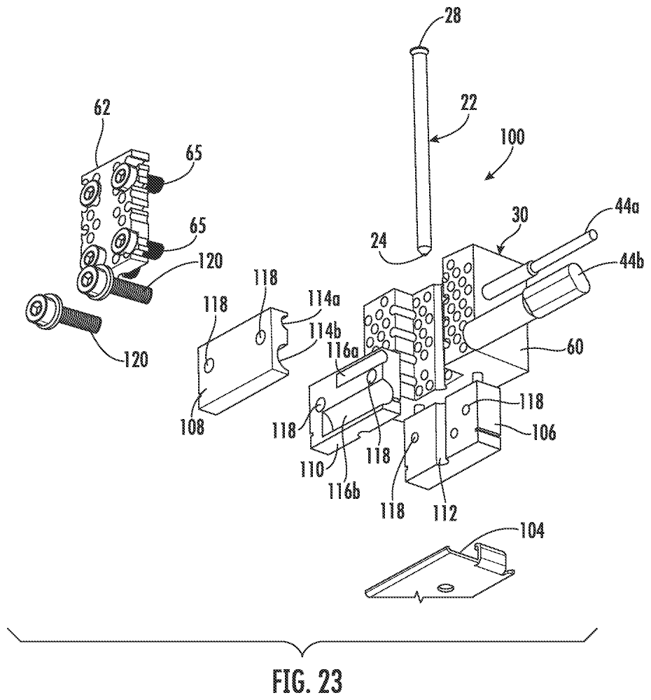

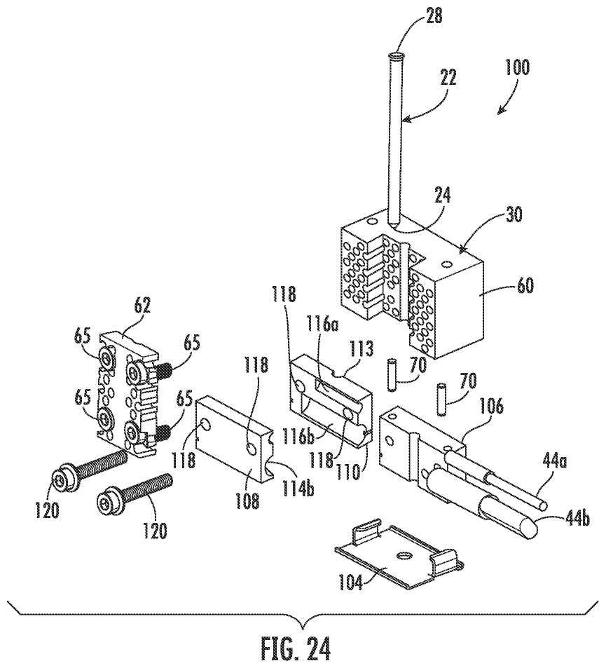

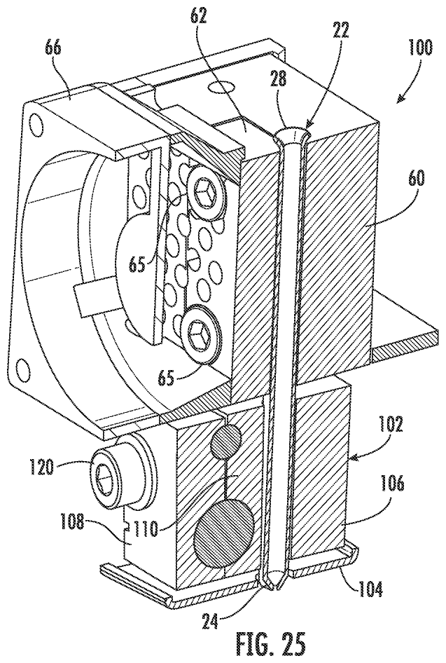

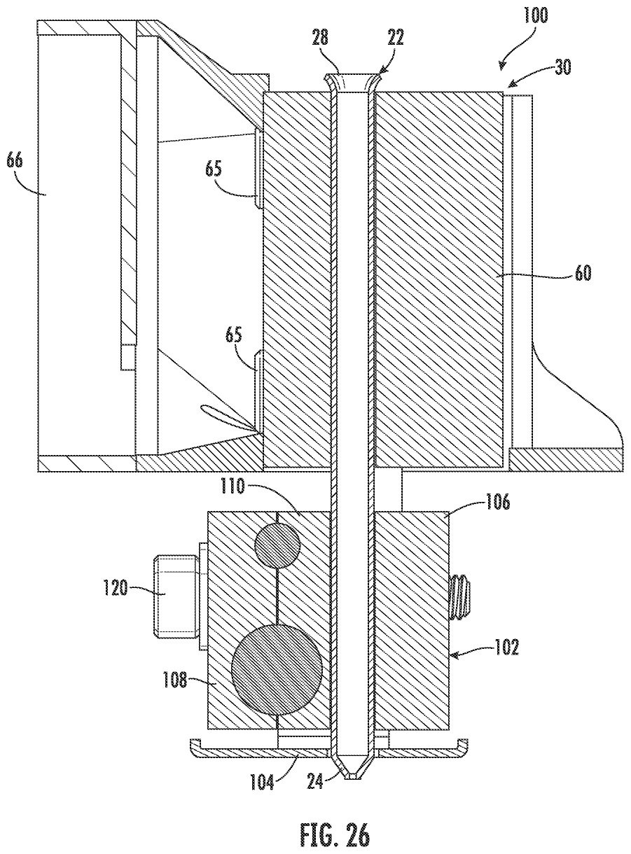

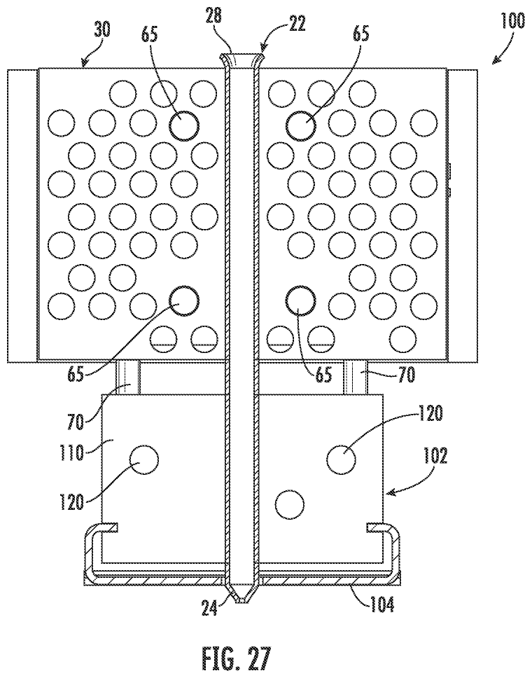

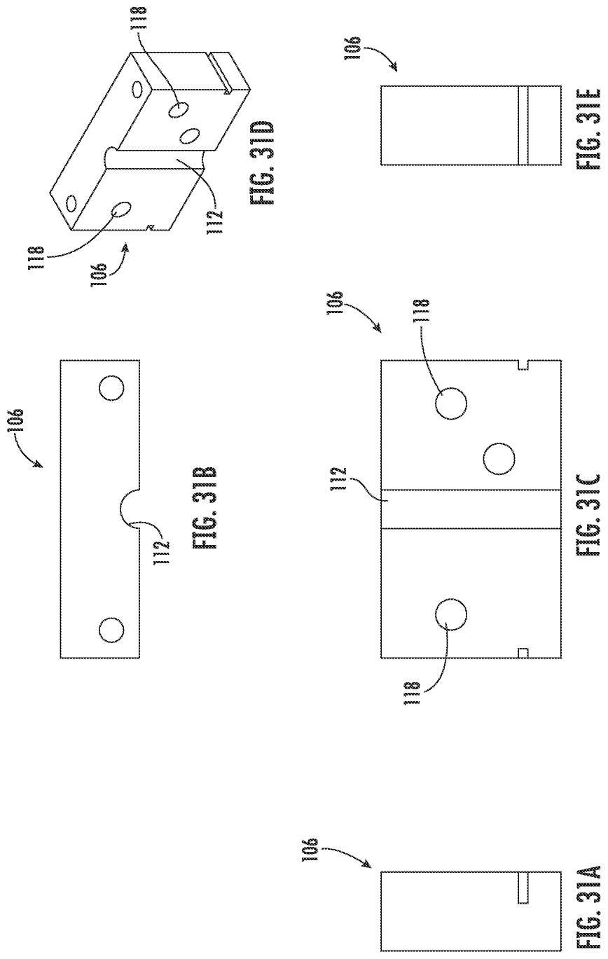

Another embodiment of a liquifier assembly for use in a print head of an extrusion-based additive manufacturing system is shown in FIGS. 14 and 15 and generally designated at 100. In this embodiment, the liquifier assembly 100 comprises a heating block 102 including three separate parts and a heat shield 104 secured to the distal end surface of the heating block 102. The heating block 102, the tube 22 and the cold block 30 are shown in FIGS. 16-24. The three-part heating block 100 comprises an inner portion 106, an outer portion 108 and a central portion 110 sandwiched between the inner portion 106 and the outer portion 108. As shown in FIG. 31, the inner portion 106 is a generally rectangular member made from a thermally conductive material, such as aluminum or copper, or other metal with high thermal conductivity, and a melting point sufficiently above the print head's maximum design operating temperature. The inner portion 106 has a thickness of about one quarter inch along a longitudinal axis. An outer surface of the inner portion has a semicircular longitudinal groove 112 for receiving the portion of the tube 22 passing through the heating block 102.

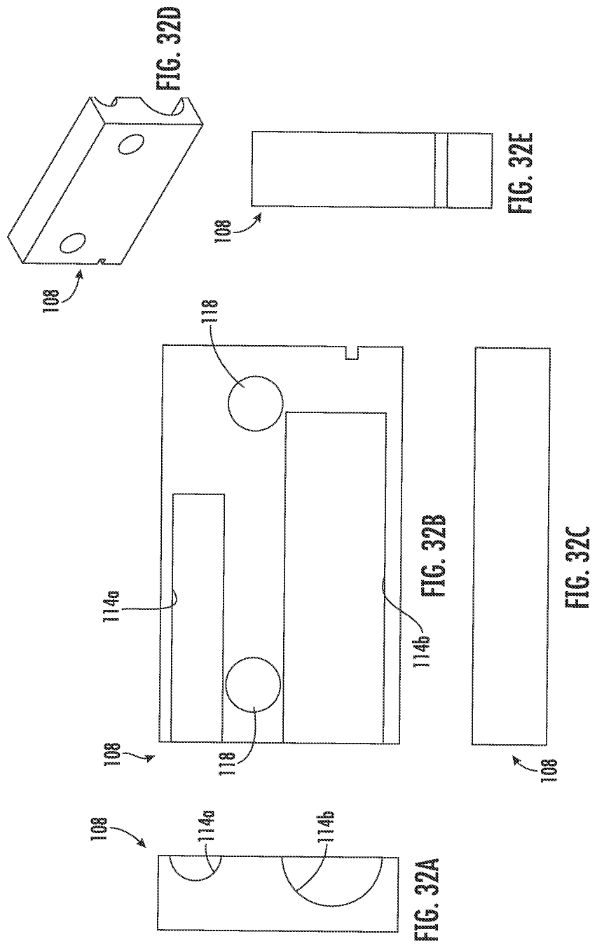

As shown in FIG. 32, the outer portion 108 of the heating block is a generally rectangular member made from a thermally conductive material, such as aluminum or copper, or other metal with high thermal conductivity, and a melting point sufficiently above the print head's maximum design operating temperature. The outer portion 108 has a thickness of about one eighth inch along a longitudinal axis. An inner surface of the outer portion defines two spaced parallel blind grooves 114a, 114b extending inwardly from one end of the outer portion 108. The bores 114a, 114b are configured for receiving the electrical lines 44a, 44b passing into the heating block 102.

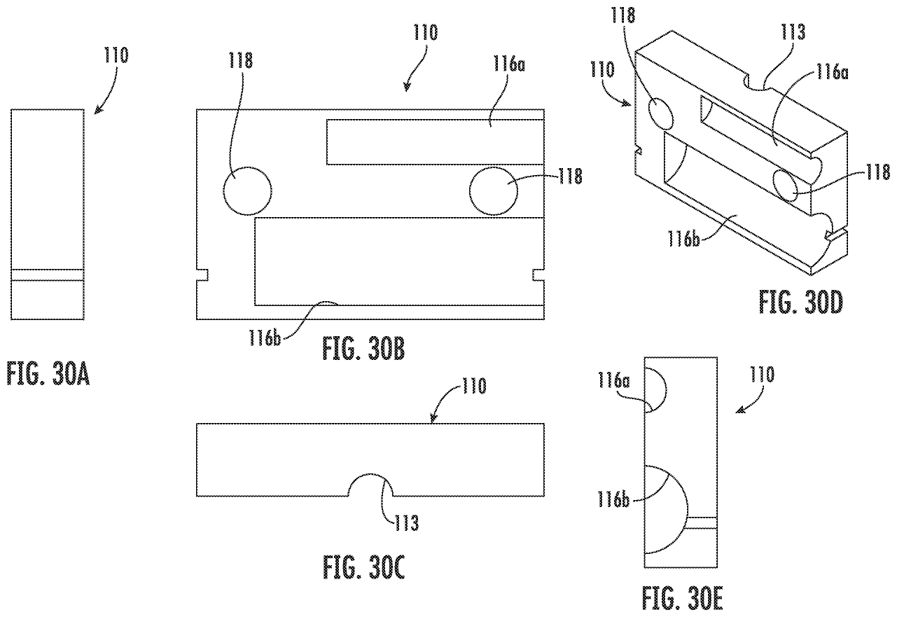

As shown in FIG. 30, the central portion 110 of the heating block is a generally rectangular member made from a thermally conductive material, such as aluminum or copper, or other metal with high thermal conductivity, and a melting point sufficiently above the print head's maximum design operating temperature. An inner surface of the central portion 110 defines a semi-circular longitudinal groove 112 such that when joined with the outer portion 106 a through passage is formed for receiving the portion of the tube 22 passing through the heating block 102. An outer surface of the central portion 110 defines two spaced parallel blind grooves 116a, 116b extending inwardly from one end of the outer portion 110. When joined with the outer portion 108, the grooves 114a, 114b, 116a, 116b form blind bores for receiving the electrical lines 44a, 44b passing into the heating block 102.

Each of the three parts of the heating block 102 has two threaded openings 118 which are aligned when assembled and receive bolts 120 for securing the parts 106, 108, 110 together. The tolerances between the three parts 106, 108, 110 of the heating block 102 are critical to achieve three things: a) achieve high thermal transfer between the three blocks to ensure even heating throughout the heating block 102 ot section assembly; b) achieve high heat transfer between the heating element and heating block, temperature sensor, and the tube; c) achieve sufficient clamping forces on the aforementioned components so that they are mechanically secure in the heating block 102 assembly. Moreover, this embodiment of the heating block 102 is cheaper and easier to manufacture since the machined parts are simple to make. Maintenance on the print head, such as changing the tube, heater, or temperature sensor, is also easier because the removal of bolts 120 provides direct access. Reliability is increased as well since there is no need to bend material to clamp the tube, heater, and temperature sensor.

The heat shield 104 prevents debris from accumulating on the bottom of the heating block 102, which could make it difficult to separate during maintenance. The heat shield also serves to block cooling air from the object cooling blower (not shown) from hitting the heating block 102 and thus removing too much heat.

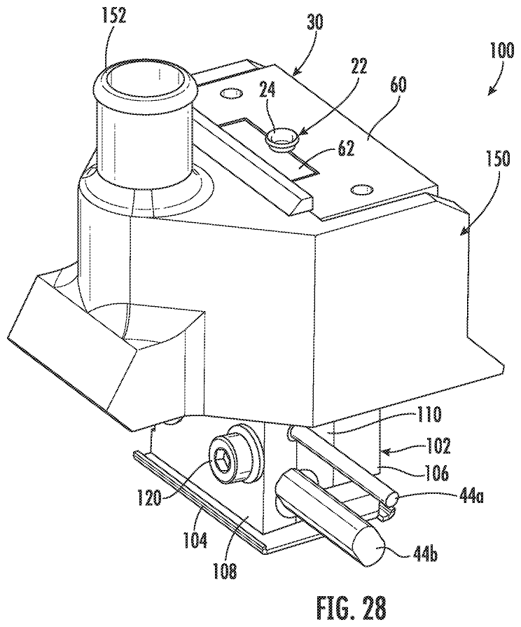

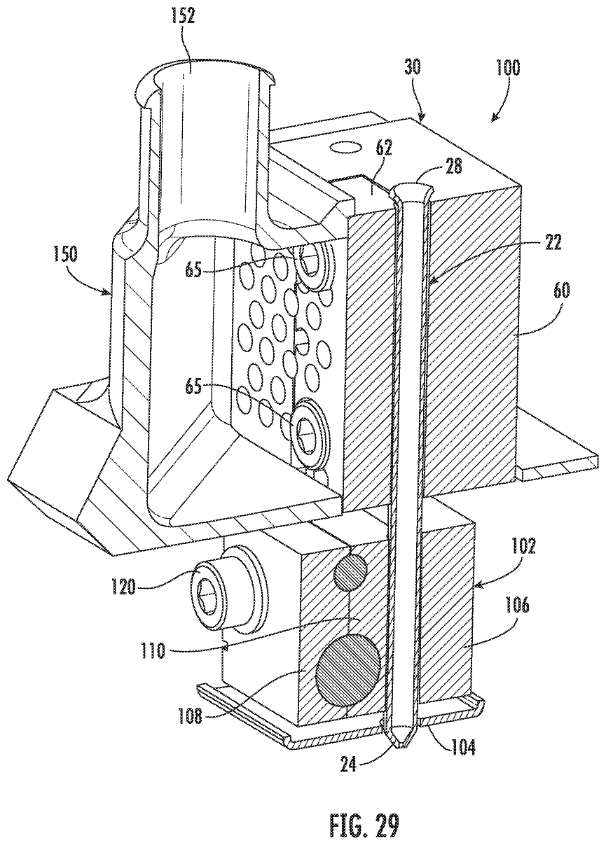

Another embodiment of means for cooling the cold block 30 is shown in FIGS. 28 and 29. In this embodiment, the cold block 30 is actively cooled with cooling air supplied via a housing 150 surrounding the cold block 30. The housing 150 includes an integral fitting 152 for attaching to an air delivery conduit connected to a blower (not shown), which is positioned outside the additive manufacturing machine's build chamber and draws in ambient air. The temperature of the tube 22 in the cold block 30 is maintained by delivery of the cooling air by the blower. This embodiment is useful in additive manufacturing machines with heated build chambers, where the ambient air temperature in the chamber is too high to sufficiently cool the cold side, or too high for small off-the-shelf cooling fans to survive for extended periods.

The liquifier assembly 22 as described herein manages the thermal energy in the modeling material by actively pulling energy out. As a result, the liquifier assembly 20 achieves the objective of keeping the length of filament of feed material in a semi-molten, or almost molten, state for as short as a time and distance along the tube 22 as possible. Generally, this will only occur in the heat break area of the tube 22. The modeling material in the portion of the tube 22 in the heating block 22 will be fully molten and the modeling material in the cold block 30 will be fully solid. The directed and localized heating and cooling of the tube 22 provides for more control over the printing process.

Another advantage of the liquifier assembly 20 is serviceability. The liquifier assembly 20 uses a low-cost, one piece tube as the entire filament path. In the event of a jam or clog, the tube 22 can be removed and discarded. The remaining parts of the liquifier assembly 20 can be reused with another tube. Moreover, this arrangement allows the tube 22 to be easily removed and replaced. The tube 22 is simply detached from the heating block 26 and the cold block 30 by unclamping, removing and replacing with a new tube 22.

The thermal performance of the liquifier assembly 20 is superior to existing prior art due to the use of a thin wall stainless tube 22 instead of thicker machined parts. Heat transfer both into and out of the filament material is higher resulting in a higher maximum flow rate through the print head. There is improved ability to modulate or control the flow rate, since the total volume of molten or semi-molten material is less than in conventional print heads. This results in more efficient operation, higher possible melt rates of material, and more controlled extrusion due to the sharper thermal gradient. Moreover, the general configuration of the print head can be easily modified for achieving multiple temperature ranges. For example, an embodiment comprising an aluminum heating block 26 and an aluminum cold block 30 can achieve a maximum temperature of about 330 degrees C. Replacing the heating block 26 with a geometrically identical copper heating block will yield a maximum temperature of about 500 degrees C. For operation in high ambient temperature environments, compressed air can be used instead of a cooling fan to deliver the airflow to cool the cold block 30. For extremely high temperature operations, or where more heat transfer is needed, the cold block 30 can be cooled by water flow instead of air. All four of these embodiments of the liquifier assembly 20 use the same tube 22 and the same operating principles. In general, to change from one configuration to another requires changing only one major component in the cold portion or the hot portion. The liquifier assembly 20 may be used to retrofit an existing additive manufacturing system. For example, the liquifier assembly 20 may be retrofitted into existing extrusion-based systems commercially available from Fusion3 without requiring any substantial changes to its extrusion parameters. This increases the ease of retrofitting by allowing the liquifier assembly 20 to be readily installed in the system for immediate use.

We claim:

1. An apparatus for liquefying a filament of a solid state material for use in an additive manufacturing system including a drive mechanism for feeding the material for printing a three dimensional object, the liquefying apparatus comprising:
a hollow tube having a longitudinal length extending between a proximal inlet end for receiving the thermoplastic material and an outlet nozzle at a distal end, the tube defining a passage for passing the material in solid and molten states;
a cold block unit mechanically attached to the tube; and
a heating block unit mechanically attached to the tube, the heating block positioned along the longitudinal axis of the tube between the cold block and the distal end of the tube for heating the tube to convert the material received at the proximal inlet end of the tube to a molten form,
wherein the material advances through the passage from the inlet end to the distal outlet end of the tube such that the molten material is extruded from the nozzle for printing each layer of the three-dimensional object.

2. A liquefying apparatus as recited in claim 1, further comprising a fan for forced air cooling of the cold block.

3. A liquefying apparatus as recited in claim 1, wherein the cold block and the heating block are spaced along the length of the tube for a distance thereby forming a heat break.

4. A liquefying apparatus as recited in claim 1, wherein the tube has a wall thickness of about 0.5 mm.

5. A liquefying apparatus as recited in claim 1, further comprising a controller configured to operate the heating block to provide a heatable zone along the longitudinal length of the tube for melting the material.

6. A liquefying apparatus as recited in claim 5, further comprising a temperature sensor configured to detect a temperature of the heating block and to relay the detected temperature to the controller.

7. A liquefying apparatus as recited in claim 1, further comprising an electrically conductive component configured to heat the heating block.

8. A liquefying apparatus as recited in claim 7, wherein the electrically conductive component comprises an electrical wire.

9. A liquefying apparatus as recited in claim 1, further comprising a heat shield positioned along the longitudinal length of the tube between the heating block and the distal end of the tube.

10. A liquefying apparatus as recited in claim 1, wherein the heating block includes a first plate having a first surface that defines a first groove, and a second plate that includes a second surface that defines a second groove, wherein the first and second surfaces of the first and second plates are in abutting contact with the first and second grooves aligned to define a passage for receiving the tube.

11. An additive manufacturing system for printing a three dimensional object, the additive manufacturing system comprising:
a drive mechanism for feeding a filament of a solid state material;
a liquefying apparatus for receiving the material, the liquefying apparatus comprising:
a hollow tube having a longitudinal length extending between a proximal inlet end for receiving the thermoplastic material and an outlet nozzle at a distal end, the tube defining a passage for passing the material in solid and molten states;
a cold block unit mechanically attached to the tube; and
a heating block unit mechanically attached to the tube, the heating block positioned along the longitudinal axis of the tube between the cold block and the distal end of the tube for heating the tube to convert the material received at the proximal inlet end of the tube to a molten form,
wherein the material advances through the passage from the inlet end to the distal outlet end of the tube such that the molten material is extruded from the nozzle for printing each layer of the three-dimensional object.

12. The additive manufacturing system as recited in claim 11, further comprising a fan for forced air cooling of the cold block.

13. The additive manufacturing system as recited in claim 11, wherein the cold block and the heating block are spaced along the length of the tube for a distance thereby forming a heat break.

14. The additive manufacturing system as recited in claim 11, wherein the tube has a wall thickness of about 0.5 mm.

15. The additive manufacturing system as recited in claim 11, further comprising a controller configured to operate the heating block to provide a heatable zone along the longitudinal length of the tube for melting the material.

16. The additive manufacturing system as recited in claim 15, further comprising a temperature sensor configured to detect a temperature of the heating block and to relay the detected temperature to the controller.

17. The additive manufacturing system as recited in claim 11, further comprising an electrically conductive component configured to heat the heating block.

18. The additive manufacturing system as recited in claim 17, wherein the electrically conductive component comprises an electrical wire.

19. The additive manufacturing system as recited in claim 11, further comprising a heat shield positioned along the longitudinal length of the tube between the heating block and the distal end of the tube.

20. The additive manufacturing system as recited in claim 11, wherein the heating block includes a first plate having a first surface that defines a first groove, and a second plate that includes a second surface that defines a second groove, wherein the first and second surfaces of the first and second plates are in abutting contact with the first and second grooves aligned to define a passage for receiving the tube.
